(19) United States
(12) Patent Application Publication
(10) Pub. No.: US 2024/0151554 A1
(43) Pub. Date: May 9, 2024

(54) TRAJECTORY EVALUATION METHOD AND APPARATUS

(71) Applicant: POSTECH Research and Business Development Foundation, Pohang-si (KR)

(72) Inventors: Hee Kap AHN, Pohang-si (KR); Tae Hoon AHN, Pohang-si (KR); Ji Woo PARK, Pohang-si (KR); Seung Jun LEE, Pohang-si (KR)

(73) Assignee: POSTECH Research and Business Development Foundation, Pohang-si (KR)

(21) Appl. No.: 18/500,041

(22) Filed: Nov. 1, 2023

(30) Foreign Application Priority Data
Nov. 4, 2022 (KR) 10-2022-0145868

(51) Int. Cl. G01C 23/00

(52) U.S. Cl. CPC G01C 23/00

(57) ABSTRACT

The present disclosure provides a method and an apparatus for quickly and accurately evaluating a trajectory of a projectile such as a satellite launching rocket or a missile by comparing the trajectory with a reference trajectory. The trajectory evaluation method includes: acquiring time series positioning data for a target and predetermined reference trajectory information; and mapping points representing the time series positioning data on a graph into corresponding points on a reference trajectory representing the predetermined reference trajectory information while relocating each mapped point onto a relocatable section taking into account a movable range dependent on a speed of the target, and determining a maximum value of distances moved by the points while the points are mapped and relocated as a similarity between the time series positioning data and the reference trajectory.

### STATEMENT REGARDING FOREIGN RIGHTS

This invention was made with Korean government support under Software Computing Industry Source Technology Development Program, 1711193606, managed by Institute for Information & Communications Technology Planning & Evaluation (IITP) supervised by Ministry of Science and ICT, Republic of Korea, and with further support under Information and Communication Broadcasting Innovation Talent Development Program, 1711193975, managed by Institute for Information & Communications Technology Planning & Evaluation (IITP) supervised by Ministry of Science and ICT, Republic of Korea.

### CROSS-REFERENCE TO RELATED APPLICATION

The present application claims a convention priority under 35 U.S.C. § 119(a) based on Korean Patent Application No. 10-2022-0145868 filed on Nov. 4, 2022, the entire content of which is incorporated herein in its entirety by reference.

### BACKGROUND

### 1. Technical Field

The present disclosure relates to a method and an apparatus for evaluating a trajectory of a moving object based on measured data and, more particularly, to a method and an apparatus for evaluating a trajectory of a moving object by comparing time series positioning data with a reference trajectory.

### 2. Description of Related Arts

A trajectory refers to a path along which a moving object moves. The growth of information and communication technology has made it possible to collect trajectory data of various moving objects through position measurement devices such as global positioning system (GPS) receivers. Trajectory data of moving objects may be utilized in various fields. For example, in a geographic information system (GIS), attempts have been made to generate an electronic road map using vehicle trajectory data. In addition, in the field of aviation, trajectory patterns are sometimes used to predict aircraft arrival time in order to avoid probable collisions or delays of aircrafts and to improve an efficiency and safety of the aircraft operation. An example thereof is disclosed in Korean Patent Publication No. 10-2016-0036310A entitled Apparatus and Method for Aircraft Arrival Time Prediction Using Trajectory Pattern.

Trajectory data may also be used to evaluate trajectories of projectiles such as a satellite launching rocket or a missile. For example, comparison of real-time positioning data received from a projectile with a preset target trajectory enables to check and improve a thrust, a load distribution, an air resistance, and an exterior design of a rocket. Meanwhile, the comparison of time series positioning data acquired by a radar for a missile launched by a hostile country with predicted trajectories estimated based on a specification obtained in advance enables to improve a prediction model or prepare countermeasures.

In general, a typical method of measuring a similarity between trajectories is a Fréchet distance. The Fréchet distance maps points on two given trajectories one-to-one and indicates a maximum value of a distance between mapped points among the mapped point pairs from a start point to an end point as a metric of a similarity. The Fréchet distance is often compared to a shortest leash that is required when paths of a person and a dog is given.

However, the calculation of the Fréchet distance requires that the input trajectories to be compared with each other should be continuous. Accordingly, in case of applying the Fréchet distance to the input time series data, the Fréchet distance may be calculated after approximating a discrete graph representing the time series data to a polygon curve connecting points indicating each time series data. However, the polygon curve generated in this way does not precisely reflect time information of the time series data. There may also be cases where the mapping corresponding to the Fréchet distance becomes unrealistic such that the Fréchet distance exceeds a maximum speed of the projectile.

A paper, Park et al., Fast Heuristic Algorithm for Similarity of Trajectories Using Discrete Fréchet Distance Measure, KIISE Transaction on Computing Practices, Vol. 22, No. 4, pp. 189-194, 2016, discloses a method of adjusting intervals of points in order to maintain each interval to be around a certain reference interval in measuring a discrete Fréchet distance for a multiple segment polygon curve. The adjustment of the point intervals may be performed by adding a new point between two points when the interval between the points is greater than the reference interval, maintaining the interval between the points when the interval between the points is the same as the reference interval, and removing a point when the points are densely populated. However, since the adjustment of the point intervals according to the method is based on an assumption that a speed of a moving object is kept constant, the accuracy of the Fréchet distance may deteriorate when the speed of the moving object increases or decreases or a speed profile of the object is changed.

### SUMMARY

Exemplary embodiments of the present disclosure provide a method and an apparatus for quickly and accurately evaluating a trajectory of a projectile such as a satellite launching rocket or a missile by comparing the trajectory with a reference trajectory.

According to an aspect of an exemplary embodiment, a trajectory evaluation method includes: acquiring time series positioning data for a target and predetermined reference trajectory information; and mapping points representing the time series positioning data on a graph into corresponding points on a reference trajectory representing the predetermined reference trajectory information while relocating each mapped point onto a relocatable section taking into account a movable range dependent on a speed of the target, and determining a maximum value of distances moved by the points while the points are mapped and relocated as a similarity between the time series positioning data and the reference trajectory.

The operation of mapping the points and determining the similarity may include: setting a similarity estimation range; choosing an estimated similarity from the similarity estimation range; and searching for the relocatable section on the reference trajectory based on the estimated similarity sequentially for all the points representing the time series positioning data and, when there are relocatable sections on the reference trajectory for all the points, determining an upper limit of the similarity estimation range or the estimated similarity as the similarity.

The operation of mapping the points and determining the similarity may further include: choosing a new estimated similarity and determining a new similarity based on the new similarity to determine the similarity or the new similarity which is smaller as an updated similarity.

The trajectory evaluation method may further include: after the upper limit of the similarity estimation range or the estimated similarity is determined as the similarity, changing the similarity estimation range. The similarity estimation range may be gradually narrowed down by a binary search technique.

The trajectory evaluation method may further include: after the upper limit of the similarity estimation range or the estimated similarity is determined as the similarity, changing the estimated similarity in the similarity estimation range; and determining an estimated similarity value allowing the relocatable sections to be present on the reference trajectory for all the points and having a minimum value while changing the estimated similarity sequentially in the similarity estimation range.

The operation of mapping the points and determining the similarity may include: determining, for each of the points representing the time series positioning data, a portion of the reference trajectory to which a distance from the corresponding point is smaller than the estimated similarity as the relocatable section for the corresponding point.

The operation of determining, for each point representing the time series positioning data, a portion of the reference trajectory to which a distance from the point is smaller than the estimated similarity as the relocatable section for the point may include: adjusting the relocatable section to include only a subset of the portion of the reference trajectory to which distances from all the points in the relocatable section for a previous point are within the movable range dependent on the speed of the target.

According to another aspect of an exemplary embodiment, a trajectory evaluation apparatus for evaluating a point sequence representing time series positioning data of a target by determining a similarity between the point sequence and a predetermined reference trajectory, includes: a memory storing program instructions; and a processor coupled to the memory and executing the program instructions stored in the memory. The program instructions, when executed by the processor, causes the processor to: acquire time series positioning data for a target and predetermined reference trajectory information; and map points representing the time series positioning data on a graph into corresponding points on a reference trajectory representing the predetermined reference trajectory information while relocating each mapped point onto a relocatable section taking into account a movable range dependent on a speed of the target, and determine a maximum value of distances moved by the points while the points are mapped and relocated as a similarity between the time series positioning data and the reference trajectory.

The program instructions causing the processor to map the points and determine the similarity may be configured to cause the processor to: set a similarity estimation range; choose an estimated similarity from the similarity estimation range; and search for the relocatable section on the reference trajectory based on the estimated similarity sequentially for all the points representing the time series positioning data and, when there are relocatable sections on the reference trajectory for all the points, determine an upper limit of the similarity estimation range or the estimated similarity as the similarity.

The program instructions causing the processor to map the points and determine the similarity may be configured to cause the processor to: choose a new estimated similarity and determine a new similarity based on the new similarity to determine the similarity or the new similarity which is smaller as an updated similarity.

The program instructions may be configured to further cause the processor to: after the upper limit of the similarity estimation range or the estimated similarity is determined as the similarity, change the similarity estimation range. The similarity estimation range may be gradually narrowed down by a binary search technique.

The program instructions may be configured to further cause the processor to: after the upper limit of the similarity estimation range or the estimated similarity is determined as the similarity, change the estimated similarity in the similarity estimation range; and determine an estimated similarity value allowing the relocatable sections to be present on the reference trajectory for all the points and having a minimum value while changing the estimated similarity sequentially in the similarity estimation range.

The program instructions causing the processor to map the points and determine the similarity may include instructions causing the processor to: determine, for each of the points representing the time series positioning data, a portion of the reference trajectory to which a distance from the corresponding point is smaller than the estimated similarity as the relocatable section for the corresponding point.

The program instructions causing the processor to determine, for each of the points representing the time series positioning data, a portion of the reference trajectory to which a distance from the corresponding point is smaller than the estimated similarity as the relocatable section for the corresponding point may include instructions causing the processor to: adjust the relocatable section to include only a subset of the portion of the reference trajectory to which distances from all the points in the relocatable section for a previous point are within the movable range dependent on the speed of the target.

### BRIEF DESCRIPTION OF THE DRAWINGS

In order that the disclosure may be well understood, there will now be described various forms thereof, given by way of example, reference being made to the accompanying drawings, in which:

FIG. 1 schematically illustrates a concept of relocating points belonging to a point sequence representing time series positioning data onto a reference trajectory to map the points belonging to the point sequence onto corresponding points on the reference trajectory during a trajectory evaluation process according to an exemplary embodiment;

FIG. 2 is a flowchart illustrating a trajectory evaluation method according to an exemplary embodiment of the present disclosure;

FIG. 3 is a flowchart illustrating in detail a process of determining a relocatable section sequentially for all points belonging to the point sequence representing the time series positioning data;

FIG. 4 illustrates an example of relocating a first and a second points belonging to the point sequence representing the time series positioning data onto the reference trajectory;

FIG. 5 is a flowchart illustrating a trajectory evaluation method according to another exemplary embodiment of the present disclosure; and

FIG. 6 is a block diagram of a trajectory evaluation apparatus according to an exemplary embodiment of the present disclosure.

The drawings described herein are for illustration purposes only and are not intended to limit the scope of the present disclosure in any way.

### DETAILED DESCRIPTION

For a clearer understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

In the description of exemplary embodiments of the present disclosure, “at least one of A and B” may mean “at least one of A or B” or “at least one of combinations of one or more of A and B”. In addition, in the description of exemplary embodiments of the present disclosure, “one or more of A and B” may mean “one or more of A or B” or “one or more of combinations of one or more of A and B”.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises.” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings. In order to facilitate general understanding in describing the present disclosure, the same components in the drawings are denoted with the same reference signs, and repeated description thereof will be omitted.

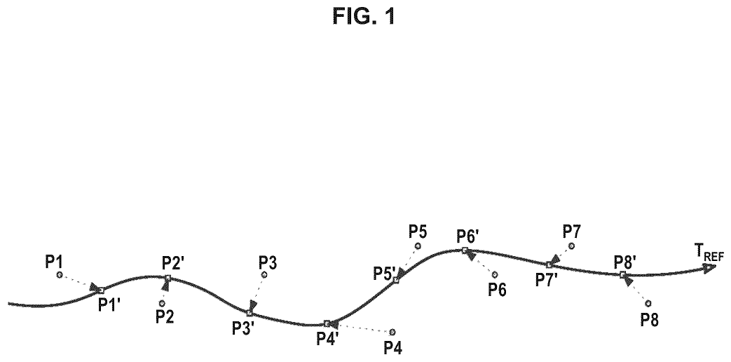

FIG. 1 schematically illustrates a concept of relocating points belonging to a point sequence representing time series positioning data onto a reference trajectory curve and mapping relocated points onto corresponding points on the reference trajectory curve during a trajectory evaluation process according to an exemplary embodiment. A trajectory evaluation apparatus of the present disclosure acquires time series positioning data for a target and evaluates a trajectory of the target by comparing the point sequence representing time series positioning data with a preset reference trajectory.

The target may be a projectile such as a satellite launching rocket and a missile, for example. However, the present disclosure is not limited thereto, and the target may be an automobile traveling on a road, another object or a human being on the road, a ship on the sea, or a manned or unmanned aerial vehicle flying in the sky. In an exemplary embodiment, the time series positioning data of the target may be determined by a GPS signal receiver mounted on the target and provided to the trajectory evaluation apparatus. In another exemplary embodiment, the time series positioning data of the target may be detected by a radar and provided to the trajectory evaluation apparatus. Alternatively, the trajectory evaluation apparatus may include the radar.

The reference trajectory, which may be generated by a user or a manufacturer of the trajectory evaluation apparatus or a third party person, may be utilized in a state of being stored in the trajectory evaluation apparatus. In an exemplary embodiment, the reference trajectory may be a theoretical trajectory generated by a mathematical modeling in a process of designing and manufacturing the target. In another exemplary embodiment, the reference trajectory may be estimated from a specification of the target. In another exemplary embodiment, the reference trajectory may be derived by statistically processing detection data accumulated in the course of the operation and monitoring of the target in various operation environments.

It is assumed that the time series positioning data and the reference trajectory data for a target represent two-dimensional location information in this specification and drawings for simplicity, and thus the time series positioning data and the reference trajectory data may be easily depicted conceptually or physically on a media such as a paper or an output device. However, the time series positioning data and the reference trajectory data may represent three-dimensional information as well. The time series positioning data for the target may be a data set including discrete values with respect to time, and each data sample may include measured time information. Accordingly, the time series positioning data for the target may be depicted by a point sequence composed of points spaced apart from each other. Meanwhile, the reference trajectory data may be substantially time-continuous data. Therefore, reference trajectory data, the reference trajectory data may be depicted by a continuous curve.

According to the trajectory evaluation method in accordance with an exemplary embodiment of the present disclosure, the trajectory of the target may be evaluated by comparing the time series positioning data for the target with the reference trajectory. In other words, the trajectory of the target is evaluated by determining a similarity between the trajectory of the target and the reference trajectory in a state that a pattern of the point sequence representing the time series positioning data for the target is matched with a pattern of the reference trajectory T_{REF}. Specifically, points P1 through P8 belonging to the point sequence representing the time series positioning data for the target may be relocated by being mapped onto corresponding points on the reference trajectory T_{REF}, and a maximum point movement required for the relocation may be determined as the similarity. That is, a maximum value of point movement distances during the relocation may be determined as the similarity, and the similarity may be used as a metric of a relocation cost. For example, assuming that the points P1-P8 indicating the time series positioning data in FIG. 1 are relocated to points P1′-P8′ on the reference trajectory T_{REF}, respectively, a maximum distance between the two corresponding points, e.g., a distance between the points P4 and P4′ associated with the maximum movement, may be determined as the similarity. Therefore, the smaller the maximum distance of the point movement required for the relocation is, the smaller the similarity is, and the point sequence of the target may be similar to the reference trajectory. The greater the maximum distance of the point movement required for the relocation is, the greater the similarity is, and the point sequence of the target may be deviated from the reference trajectory.

While the points belonging to a point sequence representing time series positioning data the time series positioning data of the projectile are mapped and relocated onto the reference trajectory, distances between any two adjacent relocated points may be limited in consideration of a longest movable range the projectile at its maximum speed. In this case, there may be a plurality of feasible relocation schemes. According to exemplary embodiments, a similarity estimation range indicating a range of values that the similarity may have may be set, and then a binary search or sequential search may be performed to determine the relocation showing the highest similarity. In this way, a substantial similarity between the time series positioning data and the reference trajectory may be determined. Further, a continuous trajectory of the projectile may be estimated from positional data of the projectile over time after the relocation of the points.

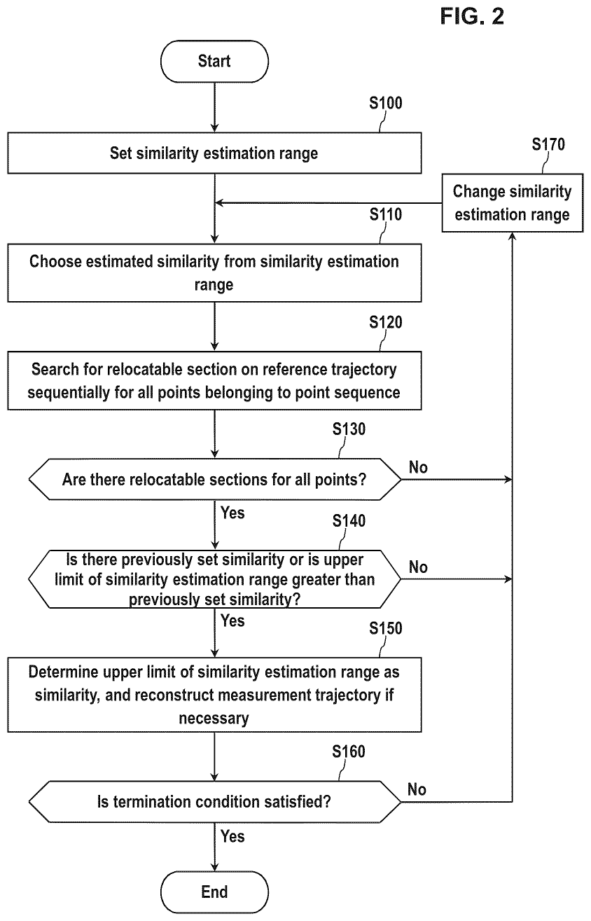

FIG. 2 is a flowchart illustrating a trajectory evaluation method according to an exemplary embodiment of the present disclosure. According to the trajectory evaluation method shown in FIG. 2, the similarity estimation range representing a range of possible similarity values is set, and then the relocation resulting in a largest similarity value is determined by the binary search, for example.

First, the similarity estimation range is set in operation 100. A lower limit of the similarity estimation range may be set to zero. An upper limit of the similarity estimation range may be set to a possible maximum value of the distance between the point sequence representing the time series positioning data and the reference trajectory. The similarity, which is an evaluation result in the trajectory evaluation method according to an exemplary embodiment of the present disclosure, may be determined by the binary search between the lower limit and the upper limit of the similarity estimation range.

In operation 110, a value is chosen as an estimated similarity from the similarity estimation range to proceed with the binary search. For example, an average of the upper limit and the lower limit of the similarity estimation range may be chosen as the estimated similarity.

Subsequently, under a premise of the chosen estimated similarity, a section to which a point belonging to the point sequence representing the time series positioning data may be relocated into is searched in the reference trajectory sequentially for all points belonging to the point sequence (operation 120). Among the points belonging to the point sequence representing the time series positioning data, some points may be relocated into a section on the reference trajectory while the other points may not be relocated into a section on the reference trajectory depending on the magnitude of the estimated similarity. Existence of a relocatable section for a point Pi on the reference trajectory means that a distance between the point Pi and a mapped point Pi′ after the relocation is smaller than the estimated similarity, and indicates that the estimated similarity is feasible for that point. On the other hand, non-existence of the relocatable section for the point Pi on the reference trajectory means that the distance between the point Pi and the mapped point Pi′ after the relocation is larger than the estimated similarity, and indicates that the estimated similarity is infeasible for that point.

In operation 130, it is determined whether there are the relocatable sections on the reference trajectory for all the points belonging to the point sequence representing the time series positioning data under the premise of the estimated similarity. In other words, it is determined whether all the points belonging to the point sequence representing the time series positioning data can be relocated onto the reference trajectory such that a distance between an original point Pi and a possible mapped point Pi′ after the relocation is smaller than the estimated similarity or not. If all the points belonging to the point sequence are relocatable onto the reference trajectory under the premise of the estimated similarity, it can be said that the estimated similarity is feasible for all the points. Therefore, when it is determined in the operation 130 that there are the relocatable sections on the reference trajectory for all the points belonging to the point sequence representing the time series positioning data, the corresponding estimated similarity may be determined to be valid, and the similarity value may be set or updated based on the current similarity estimation range.

In operation 140, it may be determined whether there is no previously set similarity value or the upper limit of the current similarity estimation range is greater than the previously set similarity value.

If it is determined in the operation 140 that there is no previously set similarity value or the upper limit of the current similarity estimation range is greater than the previously set similarity, the upper limit of the current similarity estimation range may be set as a new similarity between the time series positioning data and the reference trajectory (operation 150). Accordingly, when there is no previously set similarity, the upper limit of the current similarity estimation range may be set as the similarity. In addition, when it is determined that the upper limit of the current similarity estimation range is greater than the previously set similarity, the upper limit of the similarity estimation range may be set as an updated similarity. On the other hand, when there is the previously set similarity and the upper limit of the current similarity estimation range is smaller than or equal to the previously set similarity, the current similarity estimation range may not be used to set or update the similarity. Meanwhile, in an alternative embodiment, the estimated similarity may be set as the similarity instead of the upper limit of the current similarity estimation range in the operations 140 and 150.

In case where the similarity is set or updated in the operation 150, a measurement trajectory of the target or projectile may be reconstructed based on the time series positioning data if necessary. The measurement trajectory may be reconstructed by determining relocation positions for the points representing the time series positioning data within respective each relocatable sections. For example, the determination of the relocation positions for the points may be performed in reverse order from a last point to a first point and may be performed sequentially taking into account the movable distance according to the speed of the projectile.

In operation 160, it is determined whether a certain termination condition is satisfied, and the process is terminated when the termination condition is satisfied. When the termination condition is not satisfied in the operation 160, however, the operations 110-160 are performed again after the similarity estimation range is changed according to the binary search technique. That is, an operation of reducing a width of the similarity estimation range to be narrower than a certain error tolerance may be performed recursively by changing the lower limit or the upper limit of the similarity estimation range (operation 170) and repeatedly performing the operations 110-160. The termination condition may include, for example, that the similarity estimation range is narrower than the error tolerance, or that the similarity not updated substantially after the operations 110-170 are repeatedly performed a certain number of times or more. However, the present disclosure is not limited thereto.

On the other hand, when it is determined in the operation 130 that at least one of the points representing the time series positioning data cannot be relocated onto the reference trajectory under the premise of the estimated similarity, the similarity estimation range may be changed according to the binary search technique and the process may proceed to the operation 110. In addition, when it is determined in the operation 140 that there is the previously set similarity and the upper limit of the current similarity estimation range is smaller than or equal to the previously set similarity, the similarity estimation range may be changed according to the binary search technique and the process may proceed to the operation 110 also.

The trajectory evaluation method according to an exemplary embodiment of the present disclosure maps the points representing the time series positioning data of the projectile onto the reference trajectory by relocating the points on the reference trajectory such that the relocation with the highest similarity is calculated among the feasible relocations, and thereby enables to derive a substantial similarity between the time series positioning data and the reference trajectory. Further, the trajectory evaluation method according to an exemplary embodiment also enables to reconstruct a continuous trajectory of the projectile from the positional data of the projectile over time based on the relocation result.

When the similarity estimation range is to be changed for the application of the binary search technique, the lower limit or the upper limit of the similarity estimation range may be increased or decreased. For example, when it is determined in the operation 140 that at least one of the points representing the time series positioning data cannot be relocated onto the reference trajectory under the premise of the estimated similarity, the lower limit of the similarity estimation range may be increased, so the operations 110-160 may be performed according to an increased estimated similarity. In another example, when the operation 170 is performed according to the determination in the operation 140 or the operation 160, the upper limit of the similarity estimation range may be decreased, so the operations 110-160 may be performed according to the decreased estimated similarity.

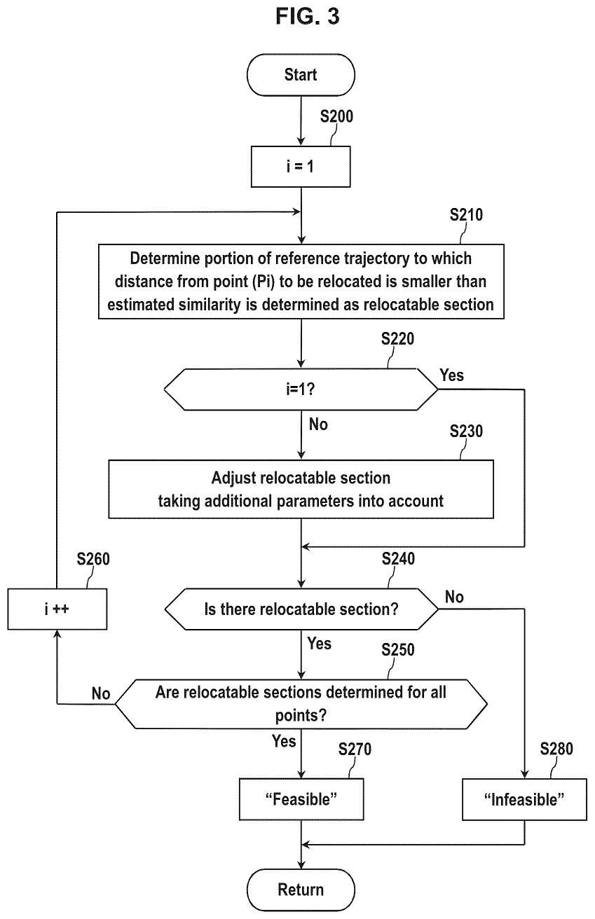

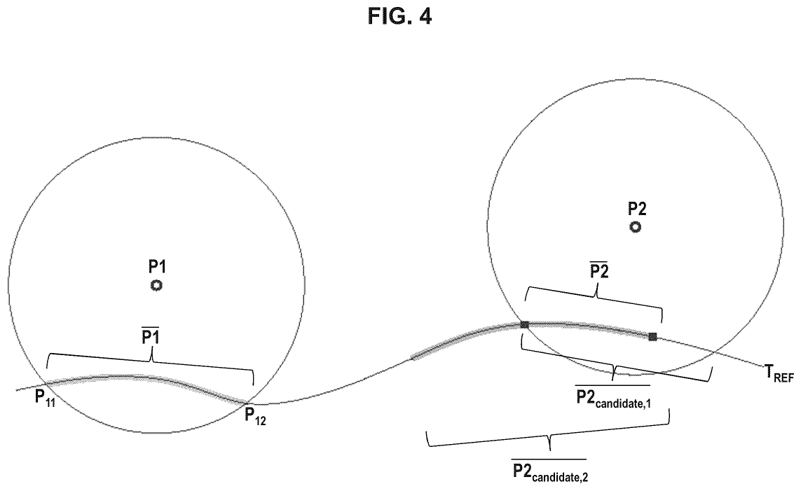

FIG. 3 is a flowchart illustrating in detail the process of determining the relocatable section sequentially for all points belonging to the point sequence representing the time series positioning data, i.e., the operation 120, and FIG. 4 illustrates an example of relocating a first and a second points belonging to the point sequence representing the time series positioning data onto the reference trajectory.

First, a portion of the reference trajectory T_{REF} to which a distance from a first point P1 of the point sequence representing the time series positioning data is smaller than the estimated similarity is determined as a relocatable section P̅1̅ for the first point P1 (operation 210). As shown in FIG. 4, the relocatable section P̅1̅ for the first point P1 is an intersection of the reference trajectory T_{REF} and an inside region of a circle centered at the first point P1 and having a radius of the estimated similarity, i.e., the portion of the reference trajectory T_{REF} inside the circle.

Next, it is determined whether there exists the relocatable section P̅1̅ for the first point P1 or not (operation 240). If it is determined in the operation 240 that there is no relocatable section P̅1̅ for the first point P1, it is determined that the corresponding estimated similarity is not feasible (operation 280), and the search process using the estimated similarity value is terminated.

Meanwhile, if it is determined in the operation 240 that there is a relocatable section P̅1̅ for the first point P1, the search for the relocatable region is attempted for a next point (operation 260). That is, the operation 210 is performed for a second point P2 to determine a portion of the reference trajectory T_{REF} to which a distance from the first point P2 of the point sequence representing the time series positioning data is smaller than the estimated similarity as a relocatable section P̅2̅ for the second point P2. Next, it is determined whether there exists the relocatable section P̅2̅ for the second point P2 or not (operation 240).

However, for the points other than the first point P1, that is, the second point P2 and subsequent points, the relocatable section may be adjusted in consideration of at least one additional parameter (operation 230). One example of the additional parameter may be a movable distance in the section according to a speed of the projectile. That is, a constraint may be placed on a distance between two points, e.g., P1′ and P2′, on the reference trajectory T_{REF} onto which two consecutive points, e.g., the first point P1 and the second point P2 of the point sequence representing the time series positioning data, respectively, are relocated. For example, the distance between the two points P1′ and P2′ may be limited by a longest possible distance according to a maximum speed of the projectile. Similarly, the distance between the two points P1′ and P2′ corresponding to the two consecutive points P1 and P2 of the point sequence representing the time series positioning data may be limited by a shortest possible distance according to a minimum speed of the projectile.

In an exemplary embodiment, after a relocatable section candidate P̅2̅_̅{̅c̅a̅n̅d̅i̅d̅a̅t̅e̅,̅1̅}̅ is determined for the second point P2 in the operation 210, only some portion of the relocatable section candidate P̅2̅_̅{̅c̅a̅n̅d̅i̅d̅a̅t̅e̅,̅1̅}̅ may be cropped and determined as the relocatable section P2 for the second point P2 taking into account the longest and/or the shortest possible distance from both ends P11 and P12 of the relocatable section P̅1̅ for the first point P1 according to the speed of the projectile in an interval between the first point P1 and the second point P2.

Alternatively, however, a relocatable section candidate P̅2̅_̅{̅c̅a̅n̅d̅i̅d̅a̅t̅e̅,̅2̅}̅ may be set first on the reference trajectory T_{REF} from both ends P11 and P12 of the relocatable section P̅1̅ for the first point P1 taking into account the longest and/or the shortest possible distance according to the speed of the projectile in the interval between the first point P1 and the second point P2. Then, a portion of the relocatable section candidate P̅2̅_̅{̅c̅a̅n̅d̅i̅d̅a̅t̅e̅,̅2̅}̅ to which the distance from the second point P2 is smaller than the estimated similarity may be determined as the relocatable section P̅2̅ for the second point P2. That is, as shown in FIG. 4, the relocatable section P2 for the second point P2 is an intersection of the relocatable section candidate P̅2̅_̅{̅c̅a̅n̅d̅i̅d̅a̅t̅e̅,̅2̅}̅ and an inside region of a circle centered at the second point P2 and having a radius of the estimated similarity, i.e., the portion of the relocatable section candidate P̅2̅_̅{̅c̅a̅n̅d̅i̅d̅a̅t̅e̅,̅2̅}̅ inside the circle.

Next, it is determined whether there exists the relocatable section P̅2̅ for the second point P2 or not (operation 240). If it is determined in the operation 240 that there is no relocatable section P̅2̅ for the second point P2, it is determined that the corresponding estimated similarity is not feasible (operation 280), and the search process using the estimated similarity value is terminated.

Meanwhile, if it is determined in the operation 240 that there is a relocatable section P̅2̅ for the second point P2, the search for the relocatable region is attempted for a next point (operation 260) until it is determined for all the points of the point sequence whether there is the relocatable section for the corresponding point or not (operation 250). The relocatable sections P̅ι̅ on the reference trajectory T_{REF} are determined for all the remaining points Pi in such a manner, and the relocatable sections may be adjusted taking into account the additional parameters such as the speed of the projectile during the process. When the relocatable sections are determined for all the points of the point sequence and the relocatable section for the last point is not an empty set, the relocation according to the estimated similarity is determined to be feasible and the process is terminated (operation 270).

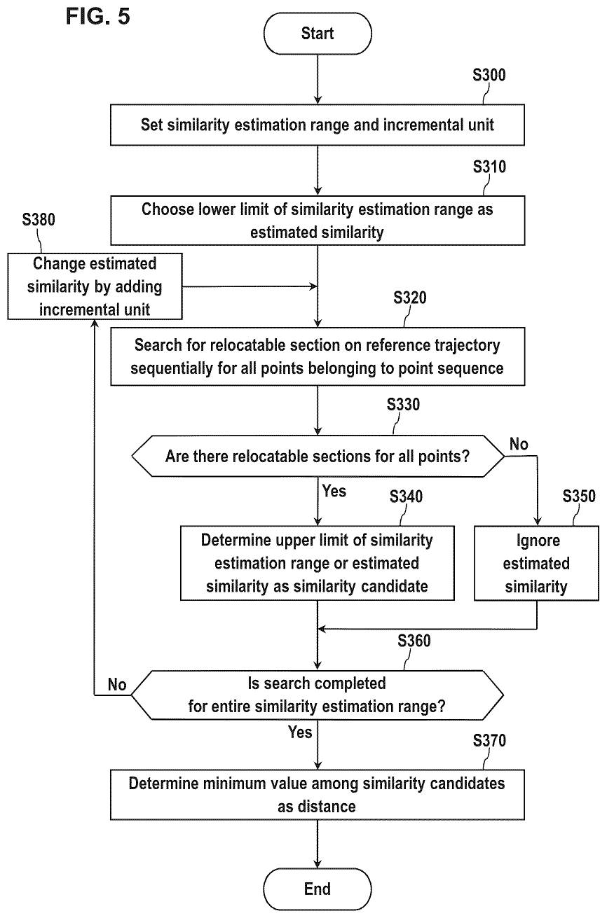

FIG. 5 is a flowchart illustrating a trajectory evaluation method according to another exemplary embodiment of the present disclosure. According to the trajectory evaluation method shown in FIG. 5, the similarity estimation range representing a range of possible similarity values is set, and then the relocation resulting in a largest similarity value is determined by the sequential search, for example.

First, the similarity estimation range representing a range of possible similarity values and an incremental unit may be set for the sequential search (operation 300). Next, the lower limit of the similarity estimation range may be chosen as the estimated similarity (operation 310).

Subsequently, under a premise of the chosen estimated similarity, a section to which a point belonging to the point sequence representing the time series positioning data may be relocated into is searched in the reference trajectory sequentially for all points belonging to the point sequence (operation 320). This operation may be performed through the process shown in FIG. 4.

In operation 330, it is determined whether there are the relocatable sections on the reference trajectory for all the points belonging to the point sequence representing the time series positioning data under the premise of the estimated similarity. When it is determined in the operation 330 that there are the relocatable sections on the reference trajectory for all the points belonging to the point sequence representing the time series positioning data under the premise of the estimated similarity, the upper limit of the corresponding similarity estimation range or the estimated similarity may be determined as a similarity candidate (operation 340). Meanwhile, when it is determined in the operation 330 that there is no relocatable section on the reference trajectory for at least one of the points belonging to the point sequence, the corresponding estimated similarity may be ignored (operation 350).

When the search for the entire similarity estimation range is not completed (operation 360), the estimated similarity is changed by adding the incremental unit, and the operations 320-360 are performed again. When it is determined that the estimated similarity reaches the upper limit of the similarity estimation range and the search for the entire similarity estimation range is completed (operation 360), a minimum value among the similarity candidates may be determined as the similarity, that is, the distance (operation 370).

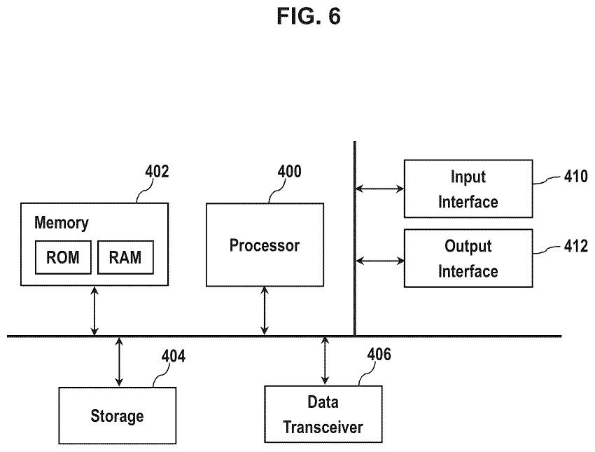

FIG. 6 is a block diagram trajectory evaluation apparatus according to an exemplary embodiment of the present disclosure. The trajectory evaluation apparatus may include a processor 400, a memory 402, a storage 404, and a data transceiver 406. In addition, the trajectory evaluation apparatus may further include an input interface device 410 and an output interface device 412. The components of the trajectory evaluation apparatus may be connected to each other by a bus.

The processor 400 may execute program instructions stored in the memory 402 or the storage 404 to perform the trajectory evaluation method according to the present disclosure. The processor 400 may include a central processing unit (CPU) or a graphics processing unit (GPU), or may be implemented by another kind of dedicated processor suitable for performing the trajectory evaluation method according to the present disclosure.

The memory 402 may include, for example, a volatile memory such as a random access memory (RAM) and a nonvolatile memory such as a read only memory (ROM). The memory 402 may load the program instructions stored in the storage 404 to provide to the processor 400 so that the processor 400 may execute the program instructions. In particular, according to the present disclosure, the memory 402 may temporarily store data generated during the program execution process for the trajectory evaluation including the reference trajectory, the time series positioning data, the similarity estimation range, the estimated similarity, and additional parameters in addition to the program instructions.

The storage 404 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD). The storage 404 may store program instructions for implementing the trajectory evaluation method according to the present disclosure.

The data transceiver 406 may receive real-time positioning data by communicating with another device, e.g., the target device itself or a detection device such as a radar. Also, the data transceiver 406 may receive the reference trajectory information from another device. The device may be configured as part of the trajectory evaluation apparatus. The input interface device 410 enables a user to input a manipulation command or the lower limit of the similarity estimation range, and the output interface device 412 may provide the trajectory evaluation result or a progress status to the user.

The device and method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A trajectory evaluation method performed by a trajectory evaluation apparatus comprising a processor, the trajectory evaluation method comprising:
acquiring time series positioning data for a target and predetermined reference trajectory information; and
mapping points representing the time series positioning data on a graph into corresponding points on a reference trajectory representing the predetermined reference trajectory information while relocating each mapped point onto a relocatable section taking into account a movable range dependent on a speed of the target, and determining a maximum value of distances moved by the points while the points are mapped and relocated as a similarity between the time series positioning data and the reference trajectory.

2. The trajectory evaluation method of claim 1, wherein mapping the points and determining the similarity comprises:
setting a similarity estimation range;
choosing an estimated similarity from the similarity estimation range; and
searching for the relocatable section on the reference trajectory based on the estimated similarity sequentially for all the points representing the time series positioning data and, when there are relocatable sections on the reference trajectory for all the points, determining an upper limit of the similarity estimation range or the estimated similarity as the similarity.

3. The trajectory evaluation method of claim 2, wherein mapping the points and determining the similarity further comprises:
choosing a new estimated similarity and determining a new similarity based on the new similarity to determine the similarity or the new similarity which is smaller as an updated similarity.

4. The trajectory evaluation method of claim 3, further comprising:
after the upper limit of the similarity estimation range or the estimated similarity is determined as the similarity, changing the similarity estimation range,
wherein the similarity estimation range is gradually narrowed down by a binary search technique.

5. The trajectory evaluation method of claim 3, further comprising:
after the upper limit of the similarity estimation range or the estimated similarity is determined as the similarity, changing the estimated similarity in the similarity estimation range; and
determining an estimated similarity value allowing the relocatable sections to be present on the reference trajectory for all the points and having a minimum value while changing the estimated similarity sequentially in the similarity estimation range.

6. The trajectory evaluation method of claim 2, wherein mapping the points and determining the similarity comprises:
determining, for each of the points representing the time series positioning data, a portion of the reference trajectory to which a distance from the corresponding point is smaller than the estimated similarity as the relocatable section for the corresponding point.

7. The trajectory evaluation method of claim 6, wherein determining, for each point representing the time series positioning data, a portion of the reference trajectory to which a distance from the point is smaller than the estimated similarity as the relocatable section for the point comprises:
adjusting the relocatable section to include only a subset of the portion of the reference trajectory to which distances from all the points in the relocatable section for a previous point are within the movable range dependent on the speed of the target.

8. A trajectory evaluation apparatus for evaluating a point sequence representing time series positioning data of a target by determining a similarity between the point sequence and a predetermined reference trajectory, comprising:
a memory storing program instructions; and
a processor coupled to the memory and executing the program instructions stored in the memory,
wherein the program instructions, when executed by the processor, causes the processor to:
acquire time series positioning data for a target and predetermined reference trajectory information; and
map points representing the time series positioning data on a graph into corresponding points on a reference trajectory representing the predetermined reference trajectory information while relocating each mapped point onto a relocatable section taking into account a movable range dependent on a speed of the target, and determine a maximum value of distances moved by the points while the points are mapped and relocated as a similarity between the time series positioning data and the reference trajectory.

9. The trajectory evaluation apparatus of claim 8, wherein the program instructions causing the processor to map the points and determine the similarity are configured to cause the processor to:
set a similarity estimation range;
choose an estimated similarity from the similarity estimation range; and
search for the relocatable section on the reference trajectory based on the estimated similarity sequentially for all the points representing the time series positioning data and, when there are relocatable sections on the reference trajectory for all the points, determine an upper limit of the similarity estimation range or the estimated similarity as the similarity.

10. The trajectory evaluation apparatus of claim 9, wherein the program instructions causing the processor to map the points and determine the similarity are configured to cause the processor to:
choose a new estimated similarity and determine a new similarity based on the new similarity to determine the similarity or the new similarity which is smaller as an updated similarity.

11. The trajectory evaluation apparatus of claim 10, wherein the program instructions are configured to further cause the processor to:
after the upper limit of the similarity estimation range or the estimated similarity is determined as the similarity, change the similarity estimation range,
wherein the similarity estimation range is gradually narrowed down by a binary search technique.

12. The trajectory evaluation apparatus of claim 10, wherein the program instructions are configured to further cause the processor to:
after the upper limit of the similarity estimation range or the estimated similarity is determined as the similarity, change the estimated similarity in the similarity estimation range; and
determine an estimated similarity value allowing the relocatable sections to be present on the reference trajectory for all the points and having a minimum value while changing the estimated similarity sequentially in the similarity estimation range.

13. The trajectory evaluation apparatus of claim 9, wherein the program instructions causing the processor to map the points and determine the similarity comprises instructions causing the processor to:
determine, for each of the points representing the time series positioning data, a portion of the reference trajectory to which a distance from the corresponding point is smaller than the estimated similarity as the relocatable section for the corresponding point.

14. The trajectory evaluation apparatus of claim 13, wherein the program instructions causing the processor to determine, for each of the points representing the time series positioning data, a portion of the reference trajectory to which a distance from the corresponding point is smaller than the estimated similarity as the relocatable section for the corresponding point comprises instructions causing the processor to:
adjust the relocatable section to include only a subset of the portion of the reference trajectory to which distances from all the points in the relocatable section for a previous point are within the movable range dependent on the speed of the target.
